(19) United States
(12) Patent Application Publication
(10) Pub. No.: US 2009/0084494 A1
(43) Pub. Date: Apr. 2, 2009

(54) Substrate manufacturing method

(75) Inventors: Jin-Yong An, Seo-gu (KR); Joon-Sung Kim, Suwon-si (KR); Jong-Kuk Hong, Suwon-si (KR); Chang-Sup Ryu, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,475

(22) Filed: Jan. 10, 2008

(30) Foreign Application Priority Data
Sep. 28, 2007 (KR) 10-2007-0098387

(51) Int. Cl. B29C 65/00

(52) U.S. Cl. 156/250

(57) ABSTRACT

A substrate manufacturing method is disclosed. A substrate manufacturing method, comprising: providing a support body on which a first separation layer is formed; forming a second separation layer on the first separation layer; forming an adhesion layer which covers the first separation layer and the second separation layer; forming a circuit stack body on the adhesion layer; cutting the circuit stack body, the adhesion layer and the second separation layer to a pre-determined shape; and forming a circuit stack unit by separating the second layer from the first layer, provides easy separation of the circuit stack pattern, which formed on the support body, from the support body and reduced manufacturing cost by reducing number of process and required materials for manufacturing coreless thin substrate.

### CROSS-REFERENCE TO RELATED APPLICATIONS

This application claims the benefit of Korean Patent Application No. 10-2007-0098387 filed with the Korean Intellectual Property Office on Sep. 28, 2007, the disclosure of which is incorporated herein by reference in its entirety.

### BACKGROUND

1. Technical Field

The present invention relates to a substrate manufacturing method.

2. Description of the Related Art

The size of electronic component for electronic devices gets smaller. Accordingly, the size of package of a device chip also gets smaller. This requires thinner substrates for the package.

Meanwhile, to minimize the loop inductance originated by physical distance of circuitry, thinner substrates are required.

According to prior substrate manufacturing methods, substrate does not provide enough stiffness for manufacturing processes without a core layer. But, involving a core layer in a substrate is a major obstacle against thinning the substrate and is a major cost increasing factor.

### SUMMARY

An aspect of the invention is to provide a substrate manufacturing method for easy separation of a circuit stack body from a support body.

One aspect of the invention provides a substrate manufacturing method, comprising: providing a support body on which a first separation layer is formed; forming a second separation layer on the first separation layer; forming an adhesion layer which covers the first separation layer and the second separation layer; forming a circuit stack body on the adhesion layer; cutting the circuit stack body, the adhesion layer and the second separation layer to a pre-determined shape; and forming a circuit stack unit by separating the second layer from the first layer.

A metal plate may be used for the support body. A metallic support body has lower cost chipper and can be recycled with limited damages in routing process etc.

The first separation layer and the second separation layer may have subsequently same composition. In this case, the same coefficient of thermal expansion of two layers makes the substrate manufacturing process more stable.

Meanwhile, the support body can be provided as an insulation plate. The support body and the first separation layer may be provided by a copper clad laminate (CCL). Also, in this case, the second separation layer may be a copper layer. The second separation layer, made of copper, may show the same coefficient of thermal expansion as the first separation layer, made of the same, and be used in forming electrode of substrate, after separating the circuit stack unit. Meanwhile, forming the second separation layer is accomplished by adhering an insulation film on a surface of the first separation layer. On occasion, a fix layer interposed between the first and the second separation layer may stable supporting.

Also, forming the second separation layer may be accomplished by coating silicon selectively on a surface of the first separation layer. For this, pre-determined shape patterned mask may be required.

Forming the circuit stack body may comprise stacking a circuit pattern by semi-additive process after forming an insulation layer on the adhesion layer, and may comprise burying a transfer pattern, formed on a carrier, into the adhesion layer

Meanwhile, with the second separation layer be conductive, the substrate manufacturing method may further comprise forming an outer via which penetrates the second separation layer and electrically connected to circuit pattern of the circuit stack body and forming a land which corresponds to the outer via by removing the second separation layer selectively, after forming the circuit stack unit.

In this case, the substrate manufacturing method may further comprise, after forming the land, forming a solder resist layer which covers the outer via and the land on a surface of the adhesion layer, forming a outer support layer on a surface of the solder resist layer, forming a stiffener by selectively removing the outer support layer to a pre-determined shape and forming a opening in a corresponding position to the outer via by selectively removing the solder resist layer.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flow chart of a substrate manufacturing method according to a first embodiment of the invention.

FIG. 2 to 13 illustrate processes of a substrate manufacturing method according to a first embodiment of the invention.

FIG. 14 to 17 illustrate processes of a substrate manufacturing method according to a second embodiment of the invention.

FIG. 18 illustrates a support body and support layers for a substrate manufacturing method according to a third embodiment of the invention.

FIG. 19 illustrates a support body, support layers and a fix layer for a substrate manufacturing method according to a fourth embodiment of the invention.

### DETAILED DESCRIPTION

Embodiments of substrate manufacturing method according to certain aspects of the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

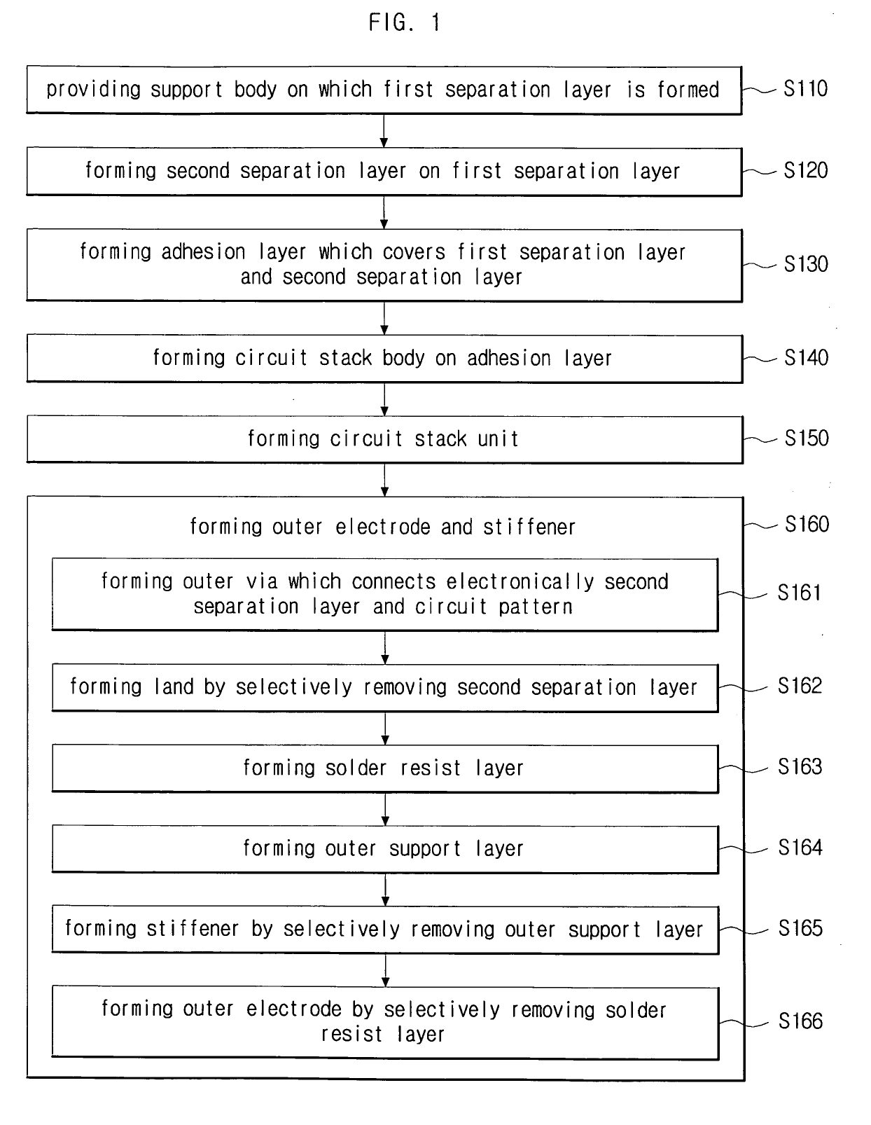

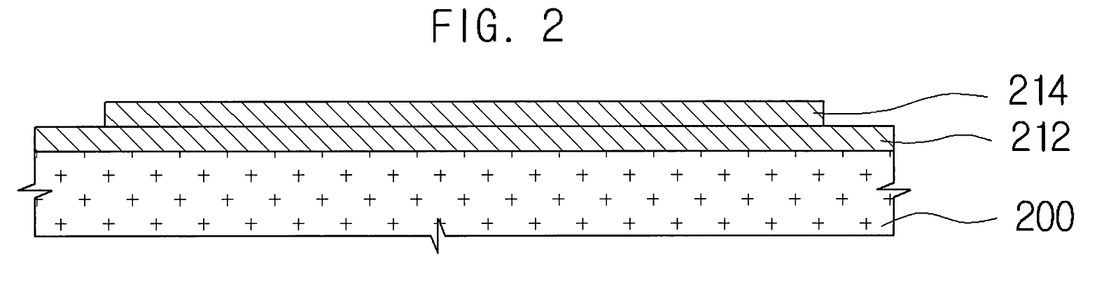

FIG. 1 is a flow chart of a substrate manufacturing method according to a first embodiment of the invention. FIG. 2 to 13 illustrate processes of a substrate manufacturing method according to a first embodiment of the invention.

In FIG. 1 to 13, are illustrated, a support body 200, a first separation layer 212, a second separation layer 214, an adhesion layer 220, a circuit stack body 230, a insulation layer 232, a circuit pattern 234, an inner via 236, a circuit stack unit 240, outer via 250, a land 216, a solder resist layer 260, an outer support layer 270, a stiffener 272, an opening 262.

Providing a support body on which a first separation layer is formed S110 is described below, referring to FIG. 2.

The support body 200 is a base on which a substrate is formed and supports a in-process product to form a substrate during transition among the process equipments. The support body 200 may be called as a carrier, because the transition is fulfilled by the support body 200.

In this embodiment, the support body 200 may be provided as an insulation material plate. The small difference between coefficients of thermal expansion of the support body 200 composed of insulation material and a substrate, prevents in-process damage by thermal expansion.

Also, the support body 200 may be provided as a metal plate. A metallic support body has lower cost chipper and can be recycled with limited damages in routing process etc. various materials may be used for support body 200. The support body 200 may be composed of various materials to satisfy to purpose of the invention.

The first separation layer 212 may provide easy separation of the circuit stack unit 240 from the support body 200 in forming circuit stack unit S150.

In this embodiment, the first separation layer 212 is copper layer and the support body 200 is composed of insulation material. The first separation layer 212 may be formed by plating copper on the support body 200 or laminating a thin copper film on the support body 200.

Meanwhile, the support body 200 with the first separation layer 212 may be provided as a copper clad laminate. Composition of the first separation layer 212 is not limited to metal like copper. An insulation film may be used to form the first separation layer 212.

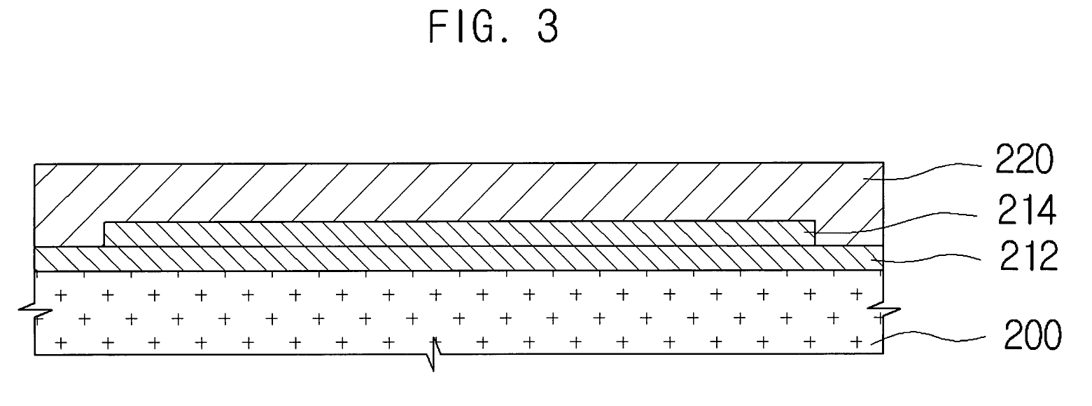

Forming second separation layer on first separation layer S120 and forming adhesion layer which covers first separation layer and second separation layer S130is described below, referring to FIG. 3.

The second separation layer 214 covers part of the first separation layer 212. The second separation layer 214 and the first separation layer 212 make subsequent forming circuit stack unit S150 to be accomplished easier. Also, if the second separation layer 214 is composed of conductive material like metal, the second separation layer 214 may remain as a part of outer electrode of substrate.

In this embodiment, the second separation layer 214 is formed by laminating a copper foil on a surface of the first separation layer 212. For example, the thickness of the copper foil may be 5 millimeter to 20 millimeter.

The adhesion layer 220 covers the first separation layer 212 and the second separation layer 214. Because the second separation layer 214 covers part of the first separation layer 212, the adhesion layer 220 and the first separation layer 212 are coupled at the area that does not covered by the second separation layer 214. The first separation layer 212 and the second separation layer 214 are fixed by the adhesion layer 220 during substrate manufacturing process.

The adhesion layer 220 may be formed by applying insulation material to cover the first separation layer 212 and the second separation layer 214. Meanwhile, the adhesion layer 220 may be formed by laminating an adhesion film with vacuum press. The adhesion layer 220 may be made of ABF Ajinomoto Build-up Film, dry film type solder resist and alternatives of solder resist material.

In this embodiment, for the first separation layer 212 and the second separation layer 214 is contacted without additional adhesion mean, the cohesion between the first separation layer 212 and the second separation layer 214 may be weaker than that between the adhesion layer 220 and each separation layer 212, 214.

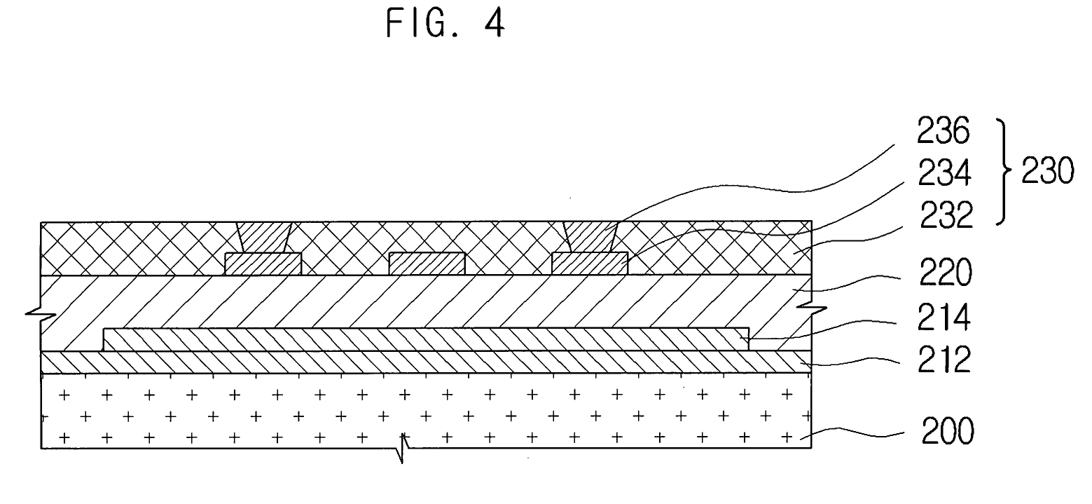

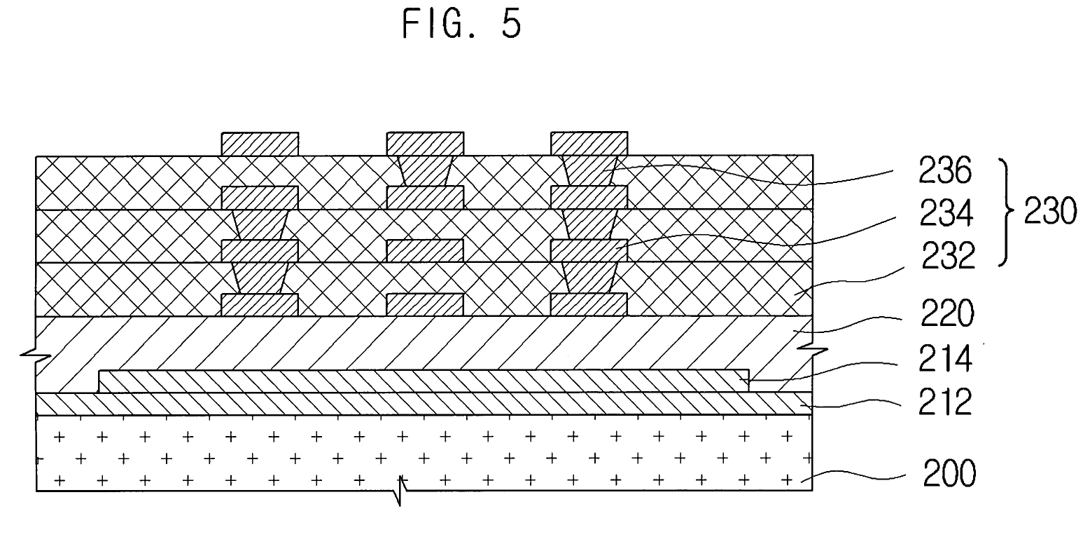

Forming circuit stack body on adhesion layer S140 is described below, referring to FIG. 4 and FIG. 5. In FIG. 4, unit circuit layer is formed on the adhesion layer 220. In FIG. 5, the circuit stack body 230, 3 unit circuit layer stacked, is formed on the adhesion layer 220.

For forming the circuit stack body 230, a subtractive process, an additive process and semi-additive process may be used. The subtractive process is a circuit forming process by unnecessary part of conductive material applied on an insulation layer. The additive process is a circuit forming process by electroless plating conductive material on an insulation layer. In the semi-additive process, after electroless plating, electro plating and etching process may be used to form a pattern. For this pattern forming, various processes including photo lithography process may be used.

For example, semi-additive process to build-up the circuit stack body 230 may be fulfilled as follows. After forming metal layer on the adhesion layer 220 by electroless plating, the circuit pattern 234 is formed by pattering the metal layer to a pre-determined shape. By applying insulation material on the circuit pattern 234, the insulation layer 232 is formed. A via hole is formed by removing a part of the insulation layer 232 that corresponds to the circuit pattern 234 with laser drilling. The inner via 236 is formed by filling via hole with metal. A unit circuit layer may be formed like this. The circuit stack body 230 including several layered circuit pattern may be formed by repeating the processes mentioned above.

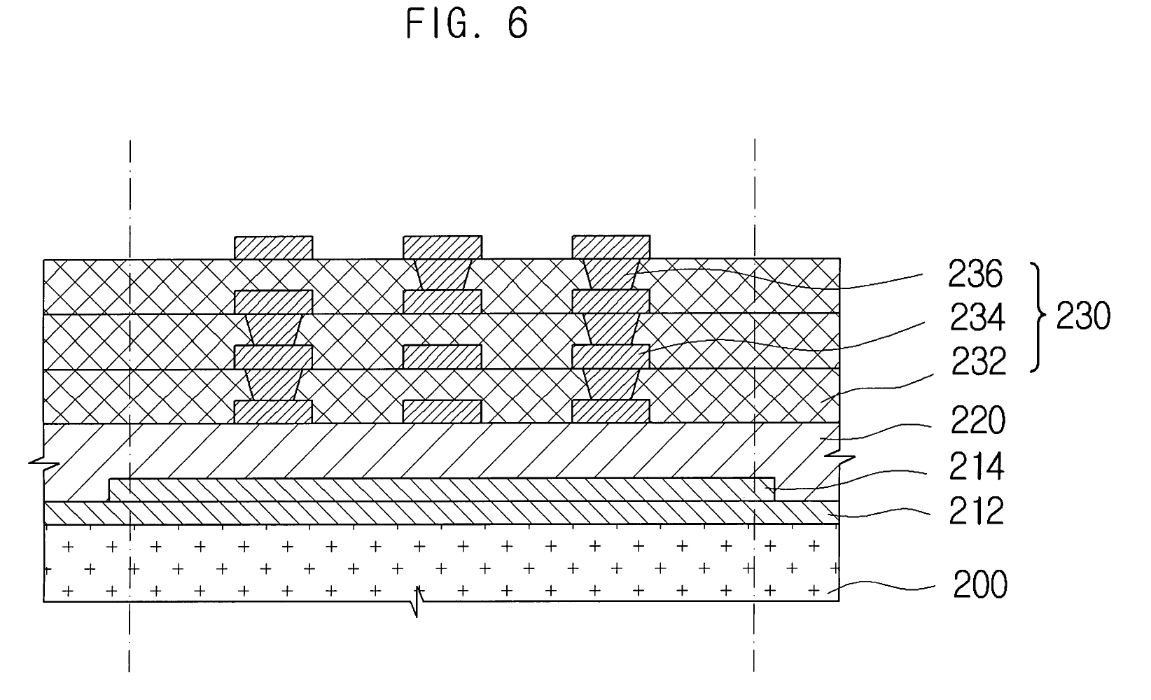

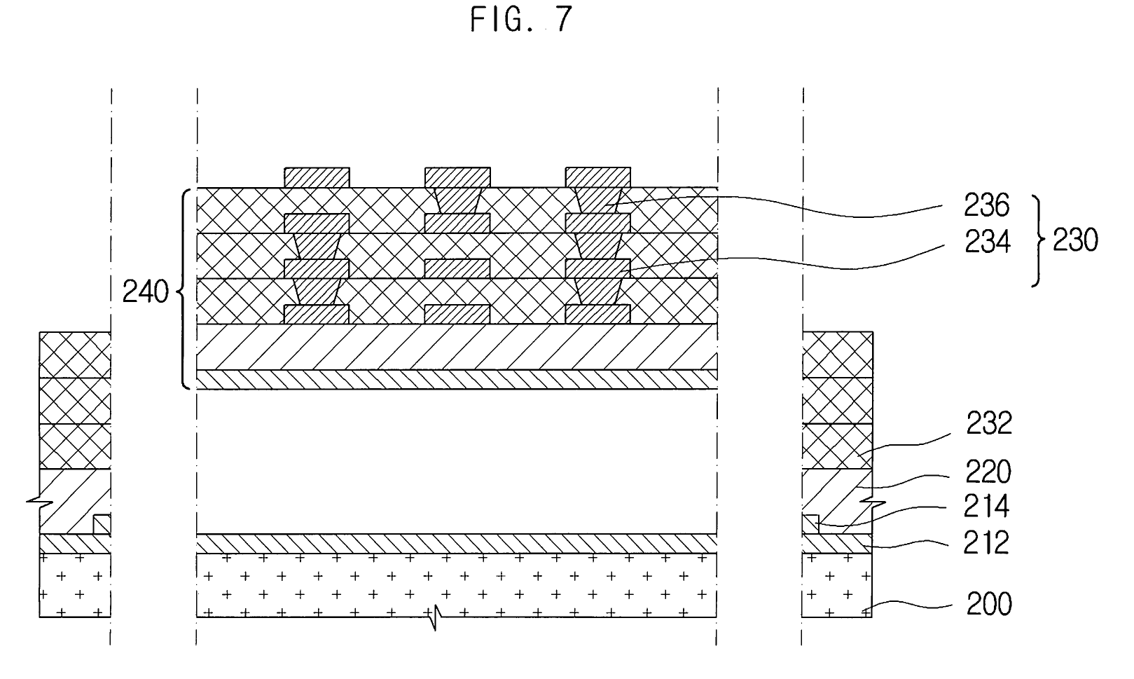

Forming circuit stack unit S150 is described below, referring to FIG. 6 and FIG. 7. For the support body 200 is utilized during the manufacture and not included in final product, separation process of the circuit stack body 230 from the support body 200 is required. The separated circuit stack body 230 from the support body 200 forms the circuit stack unit 240.

Limiting interface that serves cohesion between the circuit stack body 230 and the support body 200 to the interface between the first separation layer 212 and the second separation layer 214 interface, may have benefit of separation of the circuit stack body 230 from the support body 200.

This benefit may be provided by utilizing the remaining part of the first separation layer 212 excluding the coupled part to the adhesion layer 220. In this case, the pre-determined shape to which routing process is fulfilled is limited within the second separation layer 214.

In this embodiment, the coherence between the support body 200 and the first separation layer 212 and the coherence between the first separation layer 212 and the second separation layer 214 may be stronger than the coherence between the first separation layer 212 and the second separation layer 214. In this case, regulating the coherence between the circuit stack body 230 and the support body 200 to be provided only by the coherence between the first separation layer 212 and the second separation layer 214 with the routing process, enables easy separation of the circuit stack body 230.

Forming circuit stack unitS150 may be divided into a routing process—cutting the circuit stack body 230, the adhesion layer 220 and the second separation layer 214 to pre-determined shape and a circuit stack unit extraction process—separating the second separation layer 214 from the first separation layer 212.

In FIG. 6, a boundary for cutting the circuit stack body 230, the adhesion layer 220 and the second separation layer 214 is indicated as a dashed dotted line. The routing process may be fulfilled by cutting the circuit stack body 230, the adhesion layer 220 and the second separation layer 214 physically. The first separation layer 212 and the support body 200 may be cut during this process.

If the support body 200 is composed of metals, damage against the support body 200 in routing process may be limited. The limited damage against the support body 200 in routing process enable the support body 200 to be recycled.

After the routing process, the circuit stack unit 240 may be formed by separating the circuit stack body 230, the adhesion layer 220 and the second separation layer 214 simultaneously as in FIG. 7. The circuit stack unit 240 is cut to a pre-determined shape and comprises the circuit stack body 230, the adhesion layer 220 and the second separation layer 214 separated from the support body 200.

In this embodiment, the first separation layer 212 and the support body 200 are fully cut. But, the support body 200 may be recycled by maintaining the cutting depth not to reach the support body 200.

A substrate may be brought to completion by applying additional processes to the circuit stack unit 240 separated from the support body 200. These additional processes would be described below.

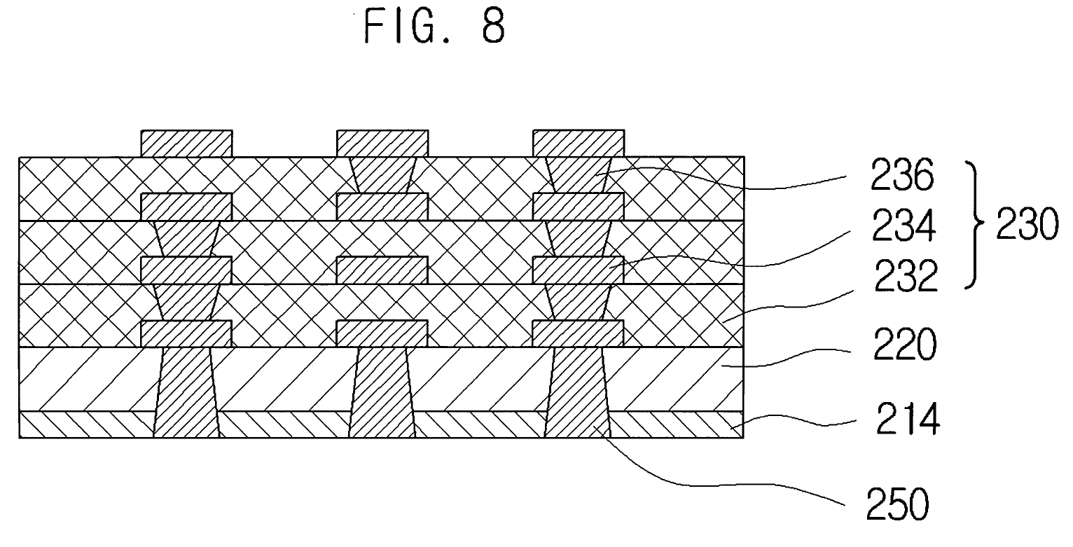

Referring to FIG. 8 to 13, forming outer electrode and stiffener S160 is described below.

In this embodiment, forming outer electrode and stiffener S160 may be divided into forming outer via which connects electronically second separation layer and circuit pattern S161, forming land by selectively removing second separation layer S162, forming solder resist layer S163, forming outer support layer S164, forming stiffener by selectively removing outer support layer S165 and forming outer electrode by selectively removing solder resist layer S166. Each steps would be described below.

Forming outer via which connects electronically second separation layer and circuit pattern S161 is described below, referring to FIG. 8.

In this embodiment the second separation layer 214 is a layer made of metal. The second separation layer 214 made of conductive material may be a electrical functional part in a substrate. The second separation layer 214 may be used to form an electrode which connects substrate to other device by subsequent process.

After forming a via hole by applying laser drilling process to the second separation layer 214 and the adhesion layer 220, the outer via 250 is formed by filling the via hole with conductive material. The outer via 250 is electrically connected to inner circuit of substrate.

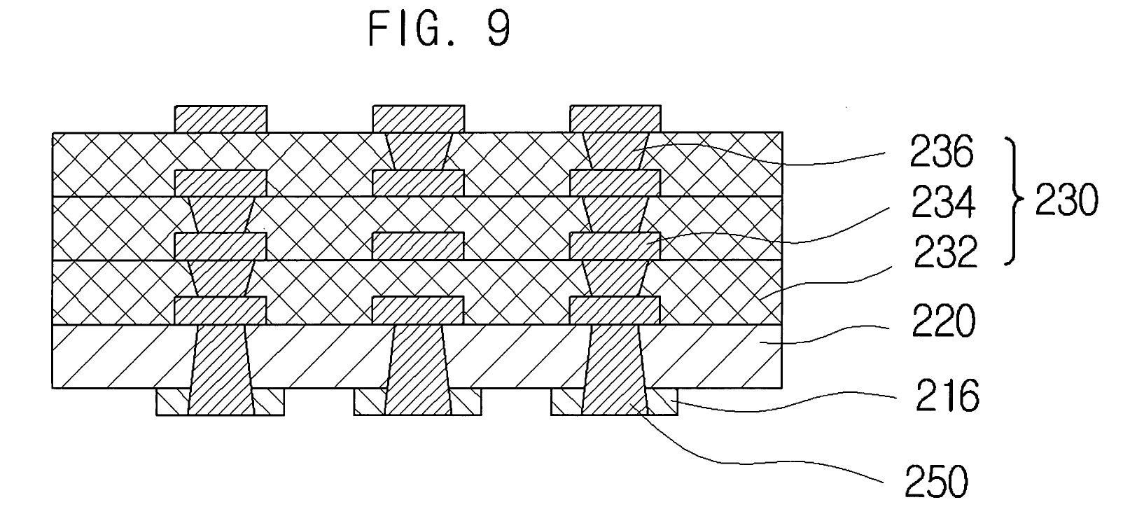

Forming land by selectively removing second separation layer S162 is described referring to FIG. 9. The land 216 may provide stable connection to outer element by expanding the contact area of outer via 250.

This step has benefits of simplifying the substrate manufacturing process and saving cost, by utilizing the second separation layer 214, used to fulfill separation of the circuit stack body 230 easily, as a part of substrate.

The second separation layer 214 may form the land 216 by removing to a pre-determined shape. For example, land 216 is formed to a circular shape around the outer via 250.

The second separation layer 214 may be patterned by similar process to forming process of the circuit pattern 234. For example, after forming etching resist pattern that covers a corresponding part of the second separation layer 214 to the land 216, the land 216 may be formed by etching the not-covered part.

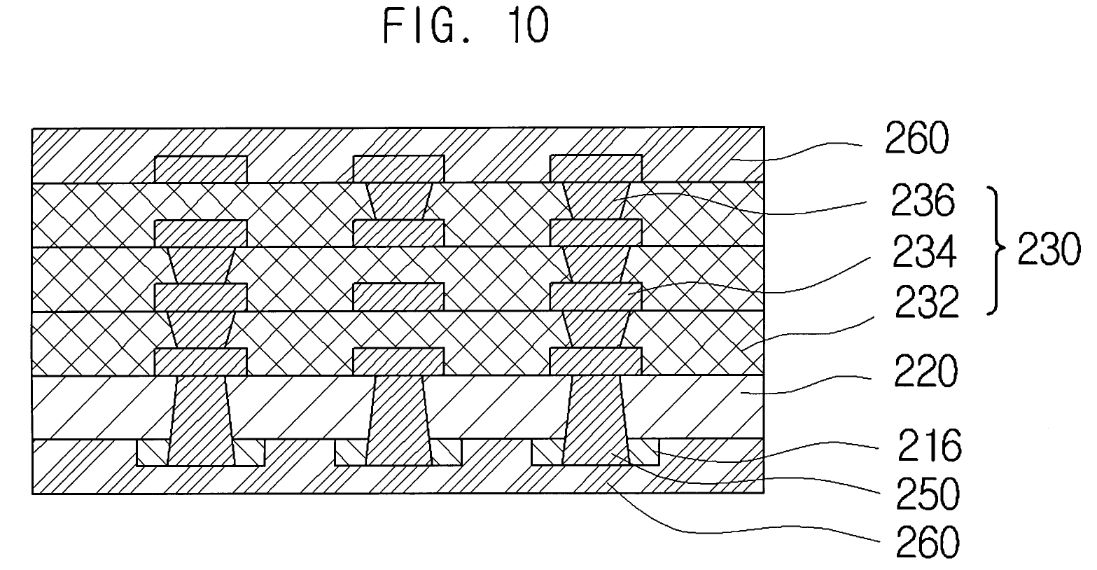

Forming solder resist layer S163 is described referring to FIG. 10. The solder resist layer 260 covers the circuit pattern 234 exposed outside the insulation layer 232 and the outer via 250 and the land 216 exposed outside the adhesion layer 220.

The solder resist layer 260 may be formed by applying insulation material to cover exposed circuit pattern 234 and outer via 250. The formed solder resist layer 260 may be selectively removed in subsequent processes and provide insulation among electrodes that exposed outside the substrate.

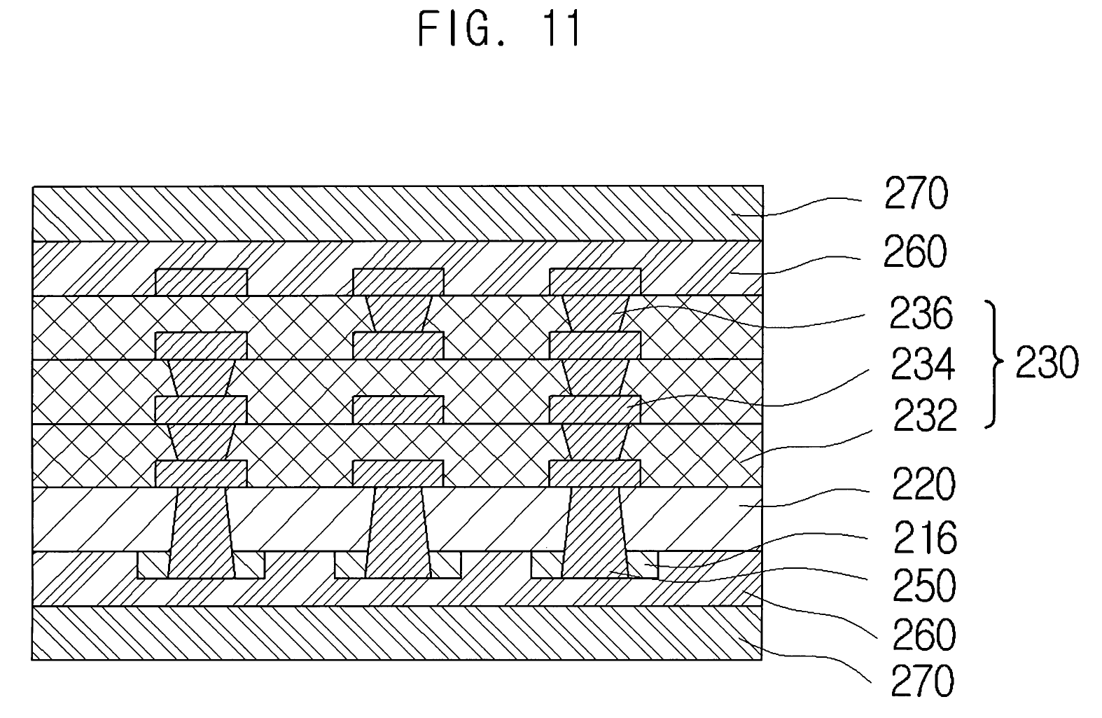

Forming outer support layer SI 64 is described referring to FIG. 11. The outer support layer 270 is formed on the solder resist layer 260.

A coreless substrate may have relatively low stiffness in the absence of a core layer. Forming reinforcement outside of a substrate may be used to give additional stiffness.

The outer support layer 270 may be formed by laminating a metal film on the solder resist layer 260 and by applying an insulation material on a solder resist layer.

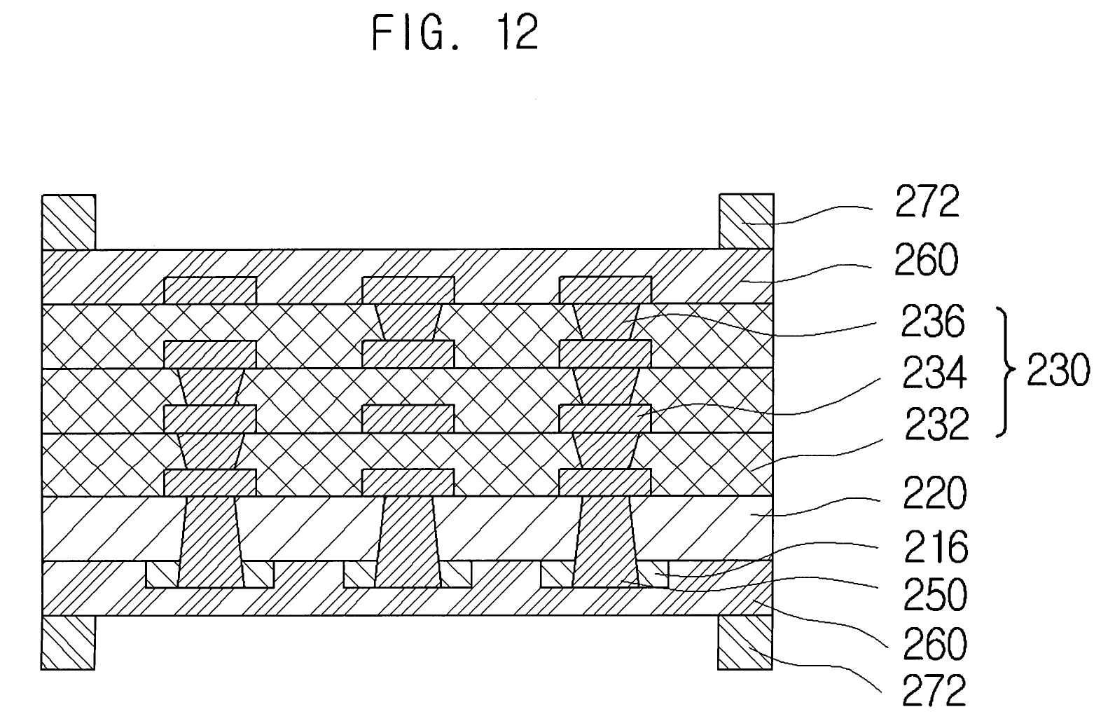

Forming stiffener by selectively removing outer support layer S165 is described referring to FIG. 12.

This step may provide spaces that can be used to serve electronic connection to outer device and provide a substrate with additional stiffness, by selectively patterning the outer support layer 270

For example, the stiffener 272 may be formed by forming etching resist pattern on the outer support layer 270 and etching corresponding part to the opening of the etching resist pattern.

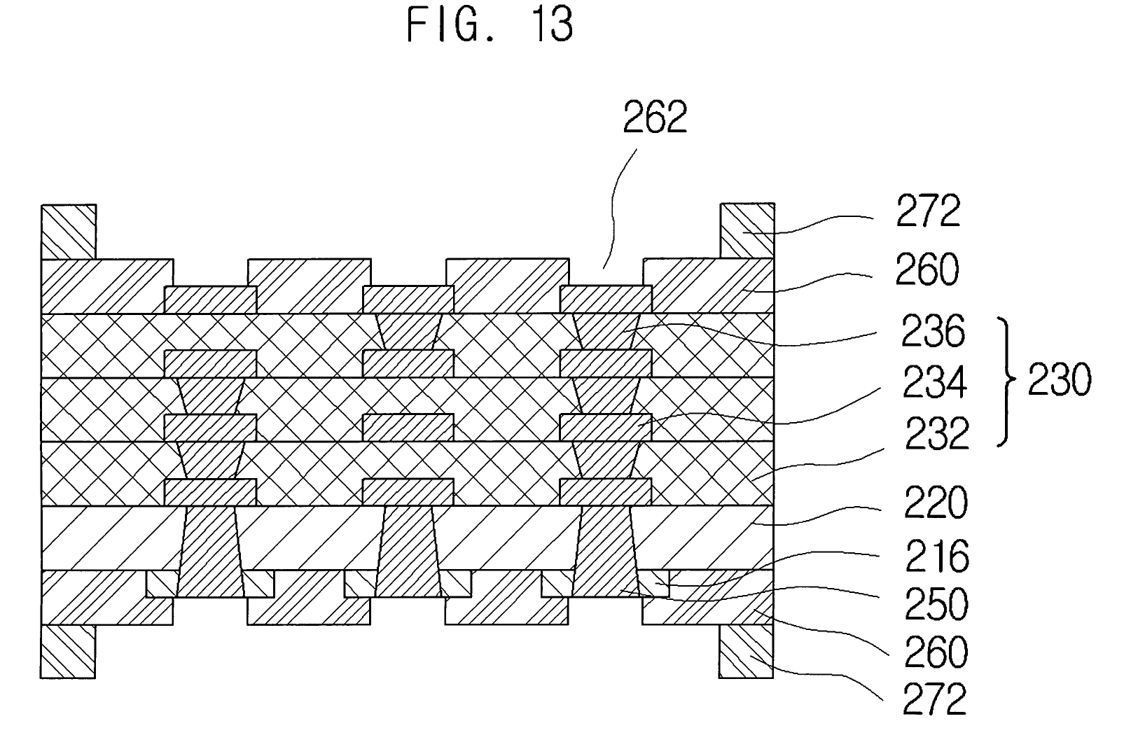

Forming outer electrode by selectively removing solder resist layer S166 is described referring to FIG. 13.

This step may provide a space for electronic connection by selectively removing the solder resist. The outer electrode may be formed by forming the opening 262 which exposes the electrode. The opening 262 may be formed by exposing the photosensitive solder resist layer 260 and removing not-exposed part with developer.

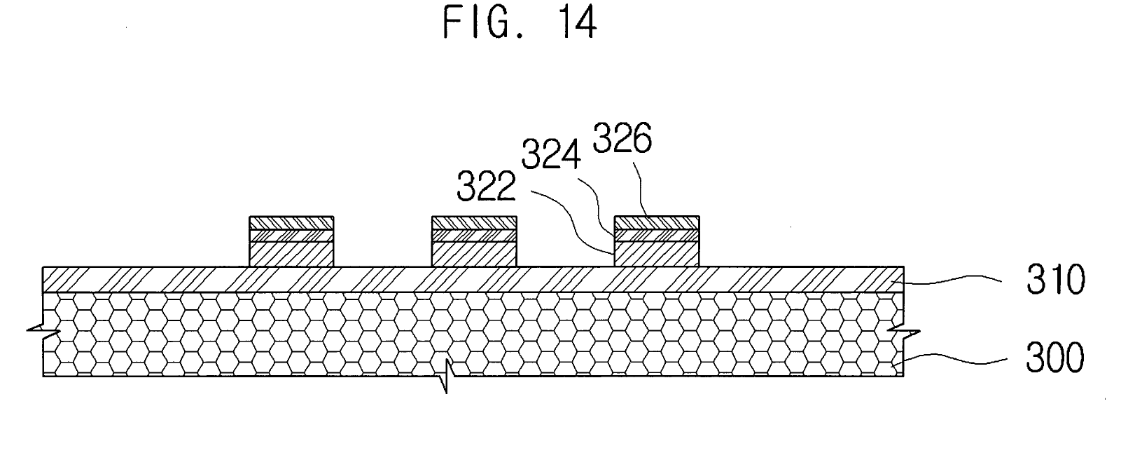

FIG. 14 to 17 illustrate processes of a substrate manufacturing method according to a second embodiment of the invention. In FIG. 14 to 17, are illustrated, a carrier 300, an etching protection film 310, a transfer pattern 322, a nickel layer 324, a gold layer 326, a circuit stack body 330, an insulation layer 332, a circuit pattern 334 and an inner via 336.

The second embodiment of the invention may be fulfilled in similar flow chart to that of the first embodiment. In this embodiment, forming the circuit stack body 330 on the adhesion layer 220 is accomplished by burying a circuit into the adhesion layer 220.

FIG. 14 illustrates forming the transfer pattern 322 on the carrier 300. In this embodiment, the carrier 300 is a metal plate, on which the etching protection film 310 is formed. The etching protection film 310 may be composed of metal like nickel etc.

The transfer pattern 322 is a circuit formed on the etching protection film 310. On a surface of the transfer pattern 322, the nickel layer 324 and the gold layer 326 are formed for corrosion protection. The transfer pattern 322 is formed by semi-additive process using metal like copper etc.

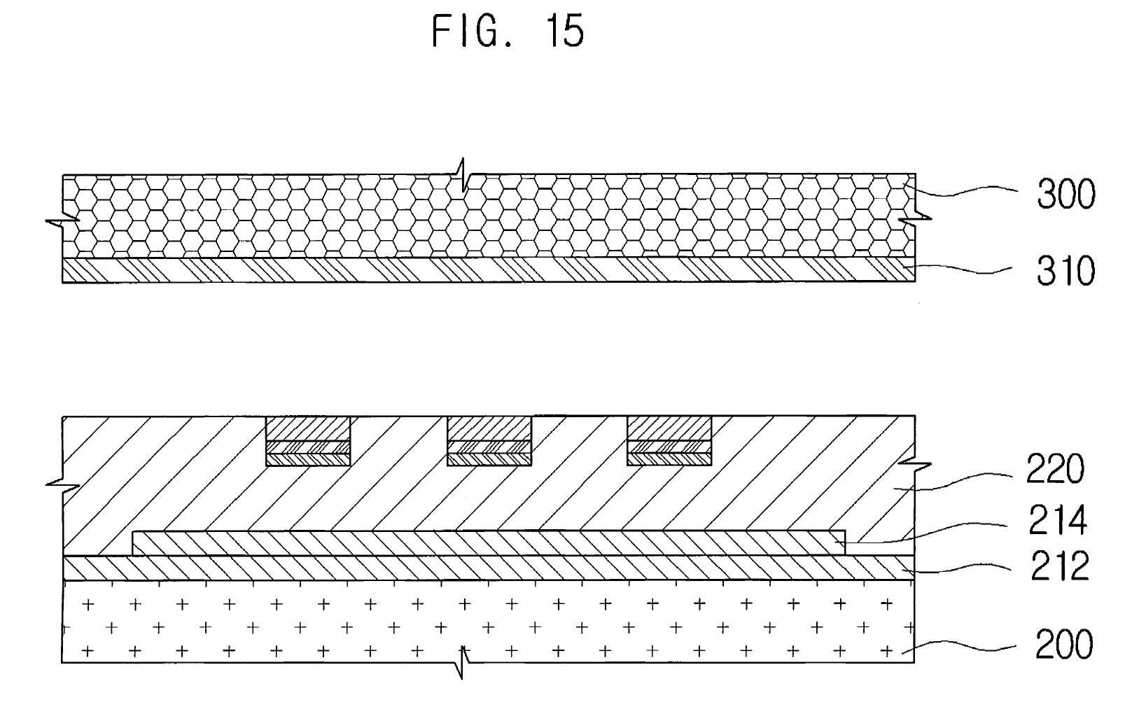

In FIG. 15 to 17, the transfer pattern 322 is buried into the adhesion layer 220, on which the insulation layer 332, the circuit pattern 334 and the inner via 336 is formed to form the circuit stack body 330. For forming the circuit stack body 330, similar process noted in the first embodiment may be used. The circuit pattern 334 may be buried into the insulation layer 332 by similar process to burying the transfer pattern 322 into the adhesion layer 220.

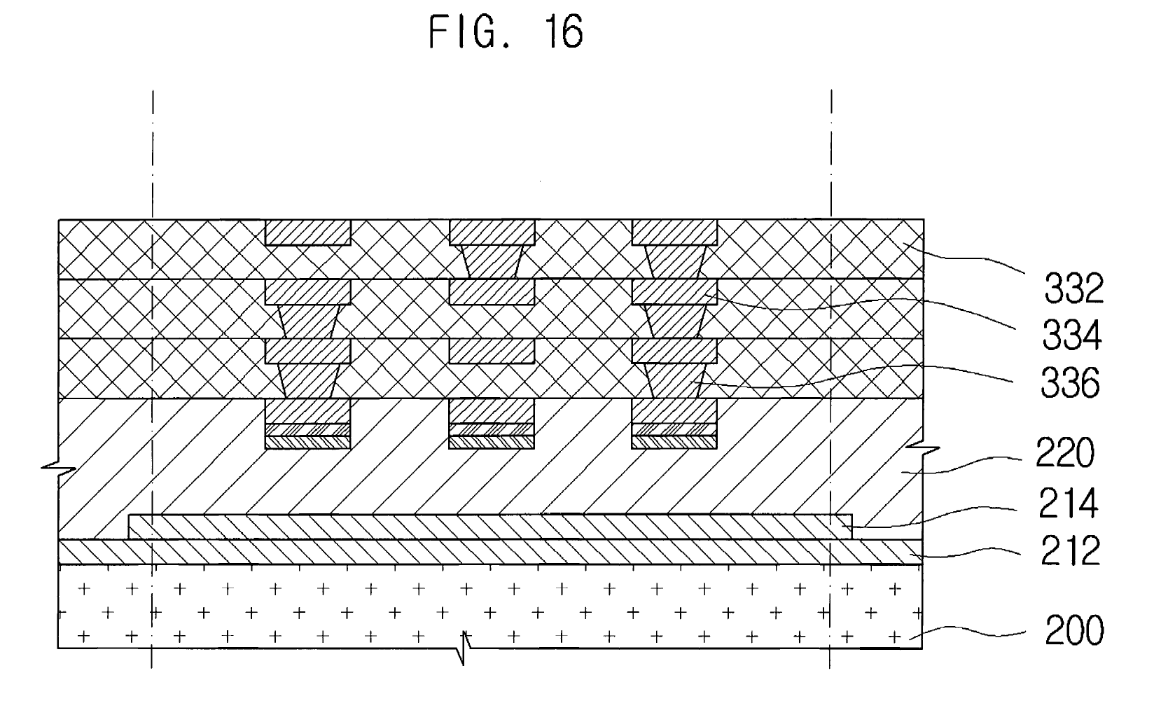

The circuit stack body 330 may be separated from the support body 200 by fulfilling a routing process according to the dashed dotted line in FIG. 16. Detail description about this is similar to the description about FIG. 6 and FIG. 7 on the first embodiment of the invention.

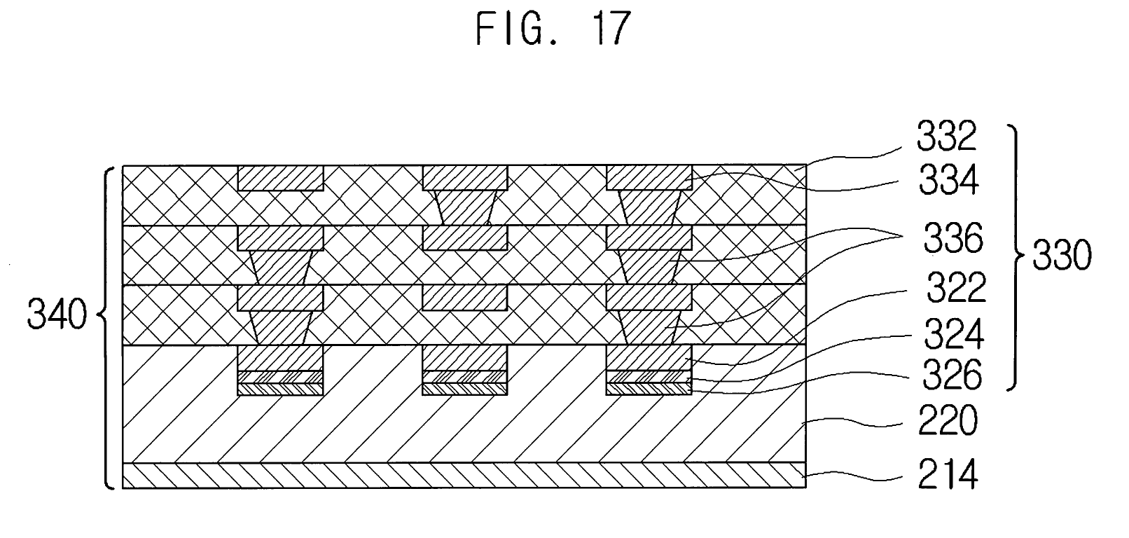

FIG. 17 illustrates the circuit stack unit 340 separated from the support body 200. The circuit stack unit 340 comprises the circuit stack body 330, the adhesion layer 220 and the second separation layer 214. An electrode may be formed with the nickel layer 324 and the gold layer 326 exposed, by removing the second separation layer 214 and the adhesion layer 200 from the circuit stack unit 340.

In the first embodiment, the outer electrode is formed using the second separation layer 214. A nickel/gold layer may be formed on the surface of outer via and land as in the first embodiment. For this embodiment, electrode is formed by burying the transfer pattern 322, on which nickel layer 324 and gold layer 326 is formed, into the adhesion layer 220.

Meanwhile, substrates may be manufactured by applying outer electrode forming process and stiffener forming process to the separated circuit stack unit 340. Descriptions for these processes were given above, about the first embodiment of the invention and necessary variation may be applied to achieve the purpose of the invention.

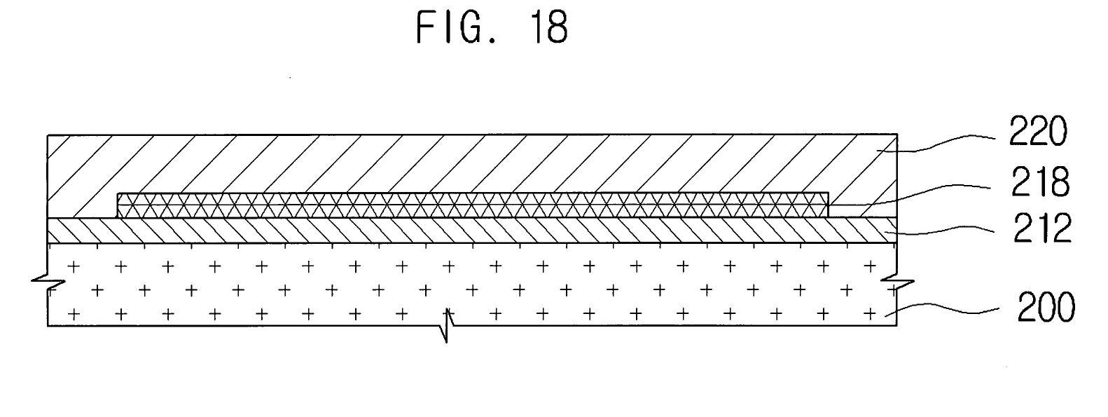

FIG. 18 illustrates a support body and support layers for a substrate manufacturing method according to a third embodiment of the invention. In FIG. 18, are illustrated, a support body 200, a first separation layer 212, a second separation layer 218, and an adhesion layer 220.

In the first embodiment of the invention, the second separation layer 214 is a copper film. The second separation layer 218 may be formed of insulation material.

In this embodiment, The support body 200 and the first separation layer 212 may be provided by a copper clad laminate. The second separation layer 218 may be provided by coating silicon on the first separation layer 212.

In this embodiment, a patterned mask may be required to form a silicon coating to pre-determined shape, because the second separation layer 218 covers part of the first separation layer 212.

The adhesion layer 220 is formed to cover the first and the second separation layer 212, 218. Subsequent process for substrate manufacturing may be understood referring description about the first and the second embodiment of the invention.

The second separation layer 218, directly coated on the first separation layer 212 and made of silicon, may have benefits of serving stable supporting during adhesion layer forming process, circuit stack body forming process and etc. and of easy separation after routing process.

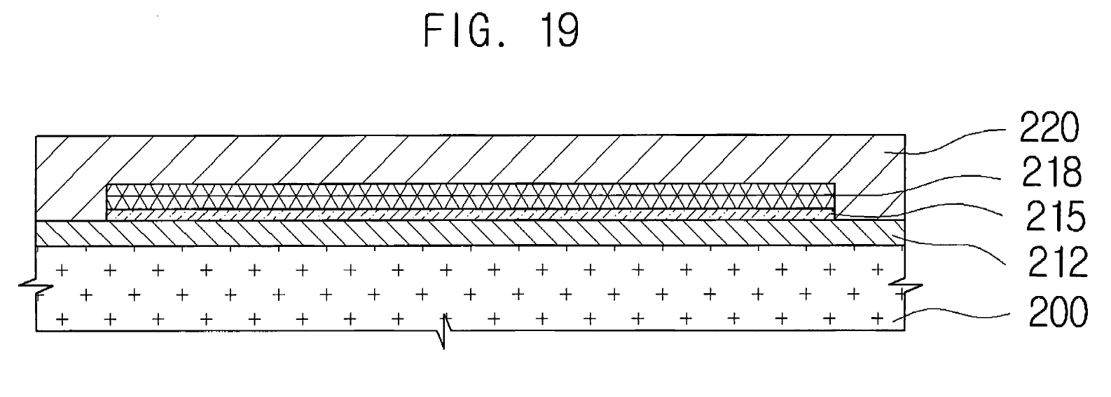

FIG. 19 illustrates a support body, support layers and a fix layer for a substrate manufacturing method according to a fourth embodiment of the invention. In FIG. 19, are illustrated, a support body 200, a first separation layer 212, a fix layer 215, a second separation layer 218 and an adhesion layer 220.

In this embodiment, the second separation layer 218 is formed by adhering an insulation film to a surface of the first separation layer 212. For example, a film made of polyethylene terephthalate PET may be used to form the second separation layer, and thickness of the film may be several-ten micrometer.

Meanwhile, The second separation layer 218 made of insulation film may contact the first separation layer 212 directly. In this case, no additional chemical process is required to form the coherence between the first and the second separation layer 212, 218 by applying pre-determined pressure.

Meanwhile, in this embodiment, the second separation layer 218 may be formed with the interposed fix layer 215. Using the fix layer 215, the cohesion between the first and the second separation layer 212, 218 may be enforced, and stable supporting in substrate manufacturing process can be obtained. For example, thickness of the fix layer may be several micrometer.

The adhesion layer 220 is formed to cover the first and the second separation layer 212, 218. Subsequent processes for manufacturing a substrate can be understood referring the above description about the first and the second embodiment of the invention.

According to certain embodiments of the invention as set forth above, the substrate manufacturing method may provides easy separation of the circuit stack pattern, which formed on the support body, from the support body and reduced manufacturing cost by reducing number of process and required materials for manufacturing coreless thin substrate.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.
The text of all pending claims, (including withdrawn claims) is set forth below. Cancelled and not entered claims are indicated with claim number and status only. The claims as listed below show added text with underlining and deleted text with strikethrough. The status of each claim is indicated with one of (original), (currently amended), (cancelled), (withdrawn), (new), (previously presented), or (not entered). Please AMEND claim 5 in accordance with the following:

1. A substrate manufacturing method, comprising:
providing a support body on which a first separation layer is formed;
forming a second separation layer on the first separation layer;
forming an adhesion layer which covers the first separation layer and the second separation layer;
forming a circuit stack body on the adhesion layer;
cutting the circuit stack body, the adhesion layer and the second separation layer to a pre-determined shape; and
forming a circuit stack unit by separating the second layer from the first layer.

2. The method of claim 1, wherein the support body is a metal plate.

3. The method of claim 1, wherein the first separation layer and the second separation layer have subsequently same composition.

4. The method of claim 1, wherein providing a support body on which a first separation layer is formed, is accomplished by providing a copper clad laminate(CCL).

5. The method of claim 4, wherein the second separation layer is composed of copper.

6. The method of claim 1, forming the second separation layer comprises coating silicon selectively on a surface of the first separation layer.

7. The method of claim 1, forming the second separation layer comprises adhering a insulation film to a surface of the first separation layer.

8. The method of claim 7, forming the second separation layer comprises forming a fix layer which interposed between the first separation layer and the second separation layer.

9. The method of claim 1, forming the circuit stack body comprises; forming a transfer pattern on a surface of a carrier, and burying the transfer pattern into the adhesion layer.

10. The method of claim 1, wherein the second separation layer is conductive,
and further comprising, after forming the circuit stack unit:
forming an outer via which penetrates the second separation layer and electrically connected to circuit pattern of the circuit stack body; and
forming a land which corresponds to the outer via by removing the second separation layer selectively.

11. The method of claim 10, further comprising, after forming the land:
forming a solder resist layer which covers the outer via and the land on a surface of the adhesion layer;
forming a outer support layer on a surface of the solder resist layer;
forming a stiffener by selectively removing the outer support layer to a pre-determined shape; and
forming a opening in a corresponding position to the outer via by selectively removing the solder resist layer.
